(19) United States
(12) Patent Application Publication
(10) Pub. No.: US 2016/0098715 A1
(43) Pub. Date: Apr. 7, 2016

(54) TRANSACTION VERIFICATION SYSTEM

(71) Applicant: Mohammad Karaki, Boca Raton, FL (US)

(72) Inventor: Mohammad Karaki, Boca Raton, FL (US)

(21) Appl. No.: 14/508,664

(22) Filed: Oct. 7, 2014

(51) Int. Cl. G06Q 20/40; G06Q 20/34

(52) U.S. Cl. CPC G06Q 20/409; G06Q 20/34

(57) ABSTRACT

According to one embodiment, a transaction verification system includes one or more processors configured to receive an indication that a card user is attempting to perform a transaction with a payment card. The processors are also configured to transmit a challenge code for reception by a card user device, and receive a first verification code from the card user device. The first verification code is selected, by the card user device, from a plurality of verification codes stored by the card user device, and according to a predefined manner. The processors are further configured to select a first comparison code according to the predefined manner, and compare the first comparison code to the first verification code. The processors are further configured to, following a determination that the first comparison code matches the first verification code, transmit a verification signal configured to indicate that the transaction has been verified.

### TECHNICAL FIELD

This disclosure relates generally to the field of transactions and more specifically to a transaction verification system.

### BACKGROUND

In order to conduct a transaction with a merchant, a customer typically pays for goods or services received from the merchant using money, a check, and/or credit/debit cards. Payments using credit/debit cards may be problematic for various reasons. For example, credit/debit cards are susceptible to fraud, which can affect the customer, merchant, and/or the financial institution associated with the customer. To prevent fraud with credit/debit cards, a merchant typically checks whether the name and/or picture on the credit/debit card matches identification provided by the customer. Such typical techniques for preventing fraud with credit/debit cards may be deficient.

### SUMMARY

According to one embodiment, a transaction verification system includes one or more memory units and one or more processors coupled to the memory units. The memory units store a plurality of comparison codes. The processors are configured to receive an indication that a card user is attempting to perform a transaction with a payment card. The processors are also configured to, following reception of the indication, transmit a challenge code for reception by a card user device. The challenge code is configured to interrogate the card user device for a first verification code. The processors are further configured to, following transmittal of the challenge code, receive the first verification code from the card user device. The first verification code is selected, by the card user device, from a plurality of verification codes stored by the card user device. Furthermore, the first verification code is selected, by the card user device, according to a predefined manner. The processors are further configured to select a first comparison code from the plurality of comparison codes according to the predefined manner, and compare the first comparison code to the first verification code received from the card user device. The processors are further configured to, following a determination that the first comparison code matches the first verification code, transmit a verification signal configured to indicate that the transaction has been verified.

Certain embodiments of the disclosure may provide one or more technical advantages. For example, in order for a transaction to be approved, the verification entity device may compare a comparison code selected by the verification entity device with a verification code selected by a card user device. As such, even if a person (or a device) is able to steal or copy a card user's payment card, the person may be unable to conduct one or more transactions using the payment card because the person may not also have the card user device (or the verification code selected by the card user device in a predefined manner). As another example, the card user device may select a particular verification code for a transaction by sequentially rotating through each of the verification codes stored by the card user device. As such, the same code may be re-used as the verification code at a later date and/or time, and the card user device may not need to receive new verification codes from the verification entity device when all of the verification codes have already been used. As a further example, a verification code stored in the card user device may be selected and/or communicated for receipt by the verification entity device without intervention by the card user. As such, the verification process may be easier for the card user.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1 illustrates an example transaction verification system that verifies transactions between card users and merchants; and

FIG. 2 illustrates an example selection of verification codes and comparison codes of FIG. 1.

### DETAILED DESCRIPTION

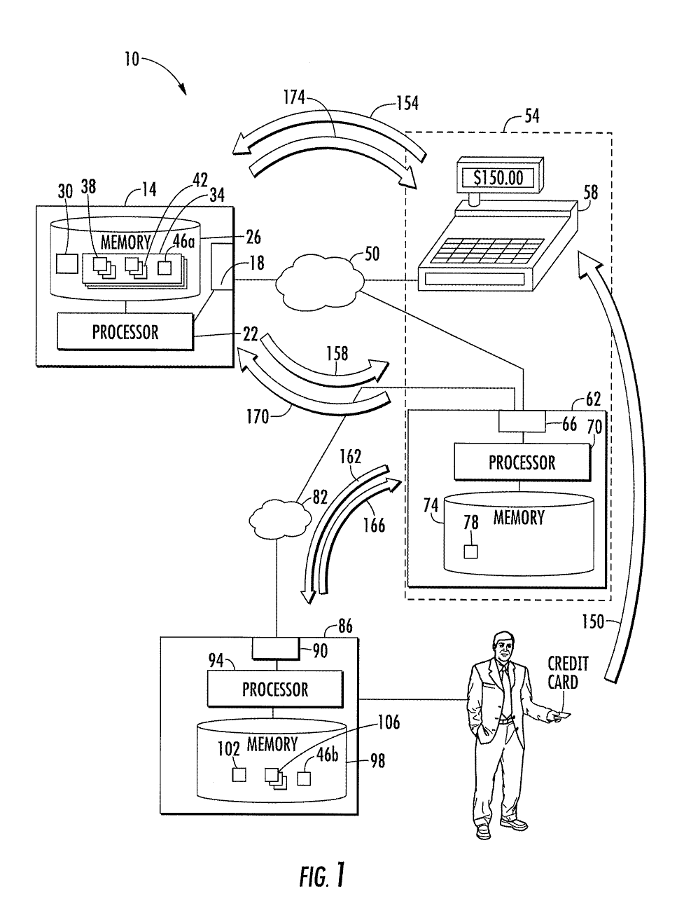

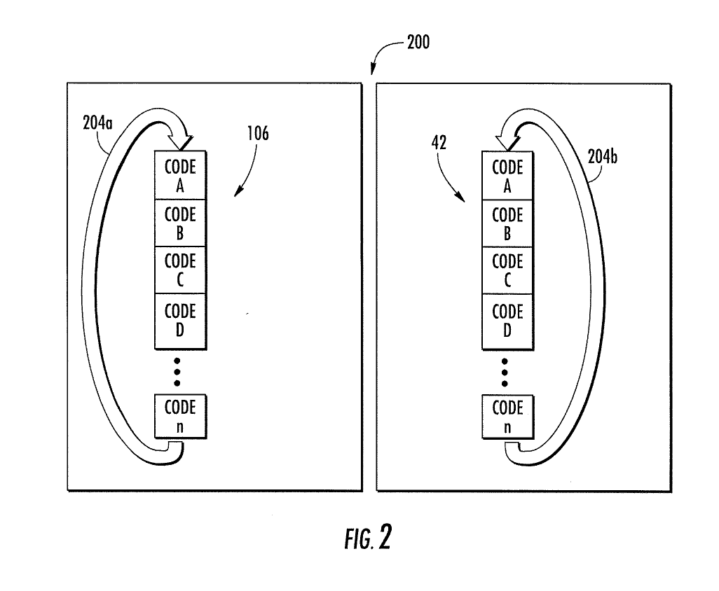

Embodiments of the present disclosure are best understood by referring to FIGS. 1-2 of the drawings, like numerals being used for like and corresponding parts of the various drawings.

FIG. 1 illustrates an example transaction verification system 10 that verifies transactions between card users and merchants. System 10 includes a verification entity device 14 that stores comparison codes 42, and further includes a card user device 86 that stores verification codes 106. When a card user attempts to perform a transaction with a payment card (e.g., a credit card), the verification entity device 14 may compare a comparison code 42 (which is selected in a predefined manner by the verification entity device 14) with a verification code 106 (which is selected in the same predefined manner by the card user device 86 and then communicated to the verification entity device 14) in order to determine whether to approve the transaction. In particular embodiments, this may provide additional protection against fraud.

A verification entity represents an entity that communicates with customers and/or merchants in order to verify transactions between the customers and merchants. For example, a verification entity may be a financial institution, such as a credit card company, credit card servicer, debit card company, debit card servicer, bank, any other institution that communicates with customers and/or merchants in order to facilitate transactions between the customers and merchants, or any combination of the preceding. In such an example, the verification entity verifies transactions for customers that have a credit card account, a savings account, a debit card account, a checking account, any other account associated with the financial institution (or a merchant), or any combination of the preceding. As another example, the verification entity may be a third party entity, such as a clearinghouse, payment processing institution, any other entity that may communicate with a financial institution in order to assist in facilitating transactions between the customers and merchants, or any combination of the preceding. In such an example, the verification entity verifies transactions for customers (and/or merchants) associated with the financial institution. As a further example, a verification entity may be a combination of a financial institution and a third party entity.

A merchant represents an entity in any suitable industry that conducts a transaction with a customer. The merchant may include a retailer, a wholesaler, a service company, or any other suitable entity that has customers and conducts transactions with the customers. The transaction may include receiving payment for goods or services from the customer or crediting a refund to the customer. The merchant interacts with the verification entity associated with a customer in order to facilitate each transaction.

A payment card represents a credit card, a debit card, a check, a coupon linked to an account, a gift card linked to an account, a money order, a promissory note, or any other manner of non-cash payment. A card user (i.e., a customer using the payment card) may use the payment card in order to pay for goods or services from a merchant.

In order to conduct a transaction with a merchant, a customer typically pays for goods or services received from the merchant using money, a check, and/or credit/debit cards. Payments using credit/debit cards may be problematic for various reasons. For example, credit/debit cards are susceptible to fraud, which can affect the customer, merchant, and/or the verification entity associated with the customer. To prevent fraud with credit/debit cards, a merchant typically checks whether the name and/or picture on the credit/debit card matches identification provided by the customer. Such typical techniques for preventing fraud with credit/debit cards may be deficient. As such, in particular embodiments, system 10 of FIG. 1 may verify transactions between card users and merchants in a manner that provide various advantages. For example, in order for a transaction to be approved, the verification entity device 14 may compare a comparison code 42 selected by the verification entity device 14 with a verification code 106 selected by a card user device 86 carried by the card user. In such an example, even if a person (or a device) is able to steal or copy a card user's payment card, the person may be unable to conduct one or more transactions using the payment card because the person may not also have the card user device 86. Furthermore, even if a person (or a device) is also able to attempt to provide a code to the verification entity device 14 (using a fraudulent device, for example), the provided code may not match the comparison code 42 utilized by the verification entity device 14 because the fraudulent device may not have access to verification codes 106 or a verification management application 46b that results in a verification code 106 being selected in a predefined manner.

As another example, the card user device 86 may select a particular verification code 106 for a transaction by sequentially rotating through each of the verification codes 106 stored at the card user device 86. In such an example, this may allow the same code to be re-used as the verification code 106 at a later date and/or time from the original use of the code. Furthermore, this may prevent the card user device 86 from needing to receive new verification codes 106 from verification entity device 14 (or some other device associated with the verification entity) when all of the verification codes 106 have already been used. As a further example, a verification code 106 stored in the card user device 86 may be selected and/or communicated for receipt by the verification entity device 14 without intervention by the card user. In such an example, the verification process may be easier for the card user because the card user may not need to perform any type of action to assist in the verification of the transaction, other than the card user actually carrying the card user device 86 with them when performing the transaction (such as carrying the card user device 86 in the card user's purse or attached to the card user's keys). As such, system 10 may verify transactions between card users and merchants in a manner that is advantageous.

Verification entity device 14 represents any suitable components that verify transactions between card users and merchants. Verification entity device 14 may include a network server, any suitable remote server, a mainframe, a host computer, a workstation, a web server, a personal computer, a file server, or any other suitable device for verifying transactions between card users and merchants. The functions of verification entity device 14 may be performed by any suitable combination of one or more servers or other components at one or more locations. In the embodiment where the verification entity device 14 is a server, the server may be a private server, and the server may be a virtual or physical server. The server may include one or more servers at the same or remote locations. Also, verification entity device 14 may include any suitable component that functions as a server. As illustrated, verification entity device 14 includes a network interface 18, a processor 22, and a memory unit 26.

Network interface 18 represents any suitable device operable to receive information from network 50, transmit information through network 50, perform processing of information, communicate to other devices, or any combination of the preceding. For example, network interface 18 receives transaction information associated with a transaction between a card user and a merchant. As another example, network interface 18 communicates a challenge code 38 for receipt by a card user device 86. Network interface 18 represents any port or connection, real or virtual, including any suitable hardware and/or software, including protocol conversion and data processing capabilities, to communicate through a local area network (LAN), a metropolitan area network (MAN), a wide area network (WAN), or other communication system that allows verification entity device 14 to exchange information with network 50, transaction environment 54, transaction device 58, merchant verification device 62, network 82, card user device 86, or other components of system 10.

Processor 22 communicatively couples to network interface 18 and memory unit 26, and controls the operation and administration of verification entity device 14 by processing information received from network interface 18 and memory unit 26. Processor 22 includes any hardware and/or software that operates to control and process information. For example, processor 22 executes verification entity device management application 30 to control the operation of verification entity device 14. Processor 22 may be a programmable logic device, a microcontroller, a microprocessor, any suitable processing device, or any combination of the preceding.

Memory unit 26 stores, either permanently or temporarily, data, operational software, or other information for processor 22. Memory unit 26 includes any one or a combination of volatile or non-volatile local or remote devices suitable for storing information. For example, memory unit 26 may include random access memory (RAM), read only memory (ROM), magnetic storage devices, optical storage devices, any other suitable information storage device, or any combination of the preceding. Additionally, memory unit 26 may be an encrypted storage device (or a storage device secured in any suitable manner), providing protection against fraudulent attempts to access the information stored in memory unit 26. While illustrated as including particular information modules, memory unit 26 may include any suitable information for use in the operation of verification entity device 14.

As illustrated, memory unit 26 includes verification entity device management application 30 and accounts 34. Verification entity device management application 30 represents any suitable set of instructions, logic, or code embodied in a computer-readable storage medium and operable to facilitate the operation of verification entity device 14. Accounts 34 represent any information regarding personal, commercial, and/or corporate accounts handled by verification entity device 14 with regard to one or more payment cards. For example, accounts 34 includes account numbers, nicknames for accounts, account identifiers associated with an account, balance information of an account (and/or a payment card linked to the account), limits of an account (and/or a payment card linked to the account), disclaimers associated with an account, card user preferences, data associated with one or more transactions performed (or in the process of being performed) by a card user, any other suitable data, or any combination of the preceding. Account 34 for each different card user (or for each account that includes multiple authorized card users) may include challenge codes 38, comparison codes 42, and verification management application 46a.

Challenge codes 38 represent any code that may be used to interrogate card user device 86 for a verification code 106. Examples of challenge codes 38 are discussed in further detail below. Comparison codes 42 represent any code that may be compared to a verification code 106 in order to verify a transaction. Examples of comparison codes 42 are discussed in further detail below. Verification management application 46a represents any suitable set of instructions, logic, or code embodied in a computer-readable storage medium and operable to provide a predefined manner of selecting comparison codes 42, verification codes 106, and/or verifying a transaction using comparison codes 42 and verification codes 106. Examples of verification management application 46a are discussed in further detail below.

Network 50 represents any suitable network operable to facilitate communication between the components of system 10, such as verification entity device 14, transaction environment 54, transaction device 58, and merchant verification device 62. Network 50 may include any interconnecting system capable of transmitting audio, video, signals, data, messages, or any combination of the preceding. Network 50 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components.

Transaction environment 54 represents any suitable components that allow card users to perform transactions with merchants. As illustrated, transaction environment 54 includes transaction device 58 and merchant verification device 62. Transaction device 58 represents any suitable components that process a transaction between a card user and a merchant. For example, transaction device 58 may include a cash register, a vending machine, a point-of-sale terminal, a personal computer, a workstation, a laptop, a mobile telephone (such as a Smartphone, or any other wireless, cellular, cordless, or satellite telephone), an electronic notebook, a personal digital assistant, any other device (wireless, wireline, or otherwise) capable of receiving, processing, storing, and/or communicating information with other components of system 10 in order to input, verify, and process a transaction between a card user and a merchant, or any combination of the preceding. Transaction device 58 may further allow transaction information to be generated and communicated to verification entity device 14 in order to perform a transaction. For example, transaction device 58 may include a card reader (such as a credit card reader) that reads a card user's payment card for the purchase, communicates the payment card information to the verification entity device 14, and processes the transaction following an indication by the verification entity device 14 that the transaction has been verified (or otherwise approved). Transaction device 58 may be associated with a merchant. For example, a particular merchant may be a retail chain that sells goods to card users. In such an example, this merchant may have one or more transaction devices 58 that allow card users to pay for the goods purchased from the merchant. Transaction device 58 may include a user interface, such as a display, a microphone, keypad, credit/debit card terminal, a scanner (such as a barcode scanner), or other appropriate terminal equipment usable by a merchant or other user.

Merchant verification device 62 represents any suitable components that communicate with verification entity device 14 and card user device 86 in order to assist in the verification of transactions between card users and merchants. Merchant verification device 62 may be a personal computer, a workstation, a laptop, a mobile telephone (such as a Smartphone, or any other wireless, cellular, cordless, or satellite telephone), an electronic notebook, a personal digital assistant, a transceiver node, a radio frequency transceiver, a smart card reader, a wired identification tag transceiver, a wireless identification tag transceiver, any other device (wireless, wireline, or otherwise) capable of receiving, processing, storing, and/or communicating information with other components of system 10, or any combination of the preceding. Merchant verification device 62 may act as an intermediary between verification entity device 14 and card user device 86. As an example, verification entity device 14 may communicate a challenge code 38 for receipt by the card user device 86. In such an example, merchant verification device 62 may receive the challenge code 38 (prior to the card user device 86 receiving the challenge code 38) and may re-communicate the challenge code 38 to the card user device 86. Additionally, the card user device 86 may communication a verification code 106 for receipt by the verification entity device 14. In such an example, the merchant verification device 62 may receive the verification code 106 (prior to the verification entity device 14 receiving the verification code 106) and may re-communicate the verification code 106 to the verification entity device 14.

Merchant verification device 62 may be associated with a merchant. For example, a particular merchant may be a retail chain that sells goods to card users. In such an example, this merchant may have one or more merchant verification devices 62 that may be connected (or otherwise associated with) a transaction device 58. As such, the merchant verification device 62 may be located at the merchant's location, and may act as an intermediary between the verification entity device 14 and the card user device 86. Merchant verification device 62 may include a user interface, such as a display, a microphone, keypad, a scanner (such as a barcode scanner), or other appropriate terminal equipment usable by a merchant or other user.

As illustrated, merchant verification device 62 includes a network interface 66, a processor 70, and a memory unit 74. Network interface 66 represents any suitable device operable to receive information from network 50 and/or network 82, transmit information through network 50 and/or network 82, perform processing of information, communicate to other devices, or any combination of the preceding. For example, network interface 62 receives a challenge code 38 from the verification entity device 14 and re-communicates the challenge code 38 to the card user device 86. As another example, network interface 62 receives a verification code 106 from the card user device 86 and re-communicates the verification code 106 to the verification entity device 14. Network interface 66 represents any port or connection, real or virtual, including any suitable hardware and/or software, including protocol conversion and data processing capabilities, to communicate through a LAN, a MAN, a WAN, or other communication system that allows network interface 66 to exchange information with verification entity device 14, network 50, transaction environment 54, transaction device 58, merchant verification device 62, network 82, card user device 86, or other components of system 10. As an example, network interface 66 may be (or may further include) a radio frequency transceiver for communicating radio frequencies to and from the card user device 86. As another example, network interface 66 may be (or may further include) a speaker/microphone for communicating audio signals (such as audio tones) to and from the card user device 86. As a further example, network interface 66 may be (or may further include) a display screen for capturing images (such as a quick response (QR) code) generated and displayed on the card user device 86, or for generating and displaying images (such as a QR code) for capture by the card user device 86.

Processor 70 communicatively couples to network interface 66 and memory unit 74, and controls the operation and administration of merchant verification device 62 by processing information received from network interface 66 and memory unit 74. Processor 70 includes any hardware and/or software that operates to control and process information. For example, processor 70 executes merchant verification device management application 78 to control the operation of merchant verification device 62. Processor 70 may be a programmable logic device, a microcontroller, a microprocessor, any suitable processing device, or any combination of the preceding.

Memory unit 74 stores, either permanently or temporarily, data, operational software, or other information for processor 70. Memory unit 74 includes any one or a combination of volatile or non-volatile local or remote devices suitable for storing information. For example, memory unit 74 may include RAM, ROM, magnetic storage devices, optical storage devices, any other suitable information storage device, or any combination of the preceding. Additionally, memory unit 74 may be an encrypted storage device (or a storage device secured in any suitable manner), providing protection against fraudulent attempts to access the information stored in memory unit 74. While illustrated as including particular information modules, memory unit 74 may include any suitable information for use in the operation of merchant verification device 62. As illustrated, memory unit 74 includes merchant verification device management application 78. Merchant verification device management application 78 represents any suitable set of instructions, logic, or code embodied in a computer-readable storage medium and operable to facilitate the operation of merchant verification device 62.

Although merchant verification device 62 is illustrated as a separate device from transaction device 58, merchant verification device 62 may the same device as transaction device 58. In such an example, a single device may be used to process the transaction and to communicate with verification entity device 14 and card user device 86 in order to assist in the verification of transactions between card users and merchants.

Network 82 represents any suitable network operable to facilitate communication between the components of system 10, such as merchant verification device 62 and card user device 86. Network 82 may include any interconnecting system capable of transmitting audio, video, signals, data, messages, or any combination of the preceding. Network 82 may include all or a portion of a PSTN, a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components. Furthermore, network 82 may be the same type of network as network 50, or network 82 may be a different type of network than network 50. For example, both network 82 and network 50 may be a combination of wireless and wireline networks. As another example, network 82 may be only a wireless network (such as only a Bluetooth network, a WiFi network, a radio frequency identification network, or an infrared network), while network 50 may be a combination of wireless and wireline networks. Additionally, although network 82 and network 50 are illustrated as separate networks, network 82 and network 50 may be the same network. In such an example, a single network may communicate a challenge code 38 from verification entity device 14 to merchant verification device 62, and may further re-communicate the challenge code 38 from merchant verification device 62 to card user device 86.

Card user device 86 represents any suitable components that communicate with verification entity device 14 and merchant verification device 62 in order to provide verification codes 106 to the verification entity device 14 to verify transactions between card users and merchants. Card user device 62 may be a personal computer, a workstation, a laptop, a mobile telephone (such as a Smartphone, or any other wireless, cellular, cordless, or satellite telephone), an electronic notebook, a personal digital assistant, a transceiver node, a wired identification tag, a wireless identification tag, a radio frequency identification device, an audio-generation device, a smart card, any other device (wireless, wireline, or otherwise) capable of receiving, processing, storing, and/or communicating information with merchant verification device 62 (and/or other components of system 10), or any combination of the preceding. Additionally, card user device 86 may include a user interface, such as a display, a microphone, keypad, a scanner (such as a QR code scanner), or other appropriate terminal equipment usable by the card user.

Card user device 86 may be carried by the card user (or otherwise associated with the card user). As such, when the card user attempts to conduct a transaction with a merchant using a payment card, card user device 86 may communicate with merchant verification device 62 (and verification entity device 14) in order to provide verification codes 106 that may allow the verification entity device 14 to verify the transaction. Card user device 86 may be carried by the card user (or otherwise associated with the card user) in any suitable manner. For example, the card user device 86 may be a wireless identification tag that is attached to the card user's keys, wallet, purse, wearable items (such as a wearable wristband), and/or article of clothing (such as a belt). As another example, the card user device 86 may be a smart card that is carried within the card user's wallet, purse, or pocket. As a further example, the card user device 86 may be the card user's mobile phone.

As illustrated, card user device 86 includes a network interface 90, a processor 94, and a memory unit 98. Network interface 90 represents any suitable device operable to receive information from network 82, transmit information through network 82, perform processing of information, communicate to other devices, or any combination of the preceding. For example, network interface 90 receives a challenge code 38 from the verification entity device 14 (via the merchant verification device 62) and communicates a verification code 106 to the verification entity device 14 (via the merchant verification device 62). Network interface 90 represents any port or connection, real or virtual, including any suitable hardware and/or software, including protocol conversion and data processing capabilities, to communicate through a LAN, a MAN, a WAN, or other communication system that allows network interface 90 to exchange information with network 82, merchant verification device 62, verification entity device 14, or other components of system 10. As an example, network interface 90 may be (or may further include) a radio frequency transceiver (such as a radio frequency identification transceiver, a Bluetooth transceiver, a WiFi transceiver, etc.) for communicating radio frequencies to and from the merchant verification device 62. As another example, network interface 90 may be (or may further include) a speaker/microphone for communicating audio signals (such as audio tones) to and from merchant verification device 62. As a further example, network interface 90 may be (or may further include) a card user display screen for capturing images (such as a QR code) generated and displayed on the merchant verification device 62, or for generating and displaying images (such as a QR code) for capture by the merchant verification device 62.

Processor 94 communicatively couples to network interface 90 and memory unit 98, and controls the operation and administration of card user device 86 by processing information received from network interface 90 and memory unit 98. Processor 94 includes any hardware and/or software that operates to control and process information. For example, processor 94 executes card user device management application 102 to control the operation of card user device 86. Processor 94 may be a programmable logic device, a microcontroller, a microprocessor, any suitable processing device, or any combination of the preceding.

Memory unit 98 stores, either permanently or temporarily, data, operational software, or other information for processor 94. Memory unit 98 includes any one or a combination of volatile or non-volatile local or remote devices suitable for storing information. For example, memory unit 98 may include RAM, ROM, magnetic storage devices, optical storage devices, any other suitable information storage device, or any combination of the preceding. Additionally, memory unit 98 may be an encrypted storage device (or a storage device secured in any suitable manner), providing protection against fraudulent attempts to access the information stored in memory unit 98. While illustrated as including particular information modules, memory unit 98 may include any suitable information for use in the operation of card user device 86.

As illustrated, memory unit 98 includes card user device management application 102, verification codes 106, and verification management application 46b. Card user device management application 102 represents any suitable set of instructions, logic, or code embodied in a computer-readable storage medium and operable to facilitate the operation of card user device 86. Verification codes 106 represent any code that may be used to identify the card user as the approved user of the payment card (as opposed to another person who may have fraudulently obtained the payment card). Examples of verification codes 106 are discussed in further detail below. Verification management application 46b may be substantially similar to verification management application 46a (stored in memory unit 34 of verification entity device 14). As such, verification management application 46b represents any suitable set of instructions, logic, or code embodied in a computer-readable storage medium and operable to provide a predefined manner of selecting verification codes 106. Verification management application 46b may be received by (and stored by) card user device 86 prior to card user device 86 receiving a challenge code 38. For example, verification management application 46b may be received by (and stored by) card user device 86 when card user device 86 is manufactured, programmed, and/or updated to operate with system 10. Furthermore, verification management application 46b may be received by (and stored by) card user device 86 at any other time. For example, verification management application 46b may be a portion of the challenge code 38 communicated for receipt by the card user device 86. In such an example, the card user device 86 may receive (and store) the verification management application 46b the first time it receives the challenge code 38 (or every time it receives the challenge code 38). As another example, verification management application 46b may be communicated to the card user device 86 in the same message as a challenge code 38, in a message prior to the communication of the challenge code 38, or in a message after the communication of the challenge code 38. As such, the card user device 86 may receive (and store) the verification management application 46b prior to receiving a challenge code 38, at the same time (or substantially the same time) as receiving a challenge code 38, or after receiving a challenge code 38. Examples of verification management application 46b are discussed in further detail below.

In an exemplary embodiment of operation, a card user may desire to conduct a transaction with a particular merchant. For example, a card user may desire to purchase an item (such as a shirt) using a payment card (such as a credit card). In order to do so, the card user may provide the merchant with the payment card (via payment 150). The merchant may then begin processing payment for the transaction by running the payment card through transaction device 58 (such as by swiping the credit card through a card reader of transaction device 58). As a result of running the payment card through transaction device 58, transaction device 58 may provide an indication (via indication 154) to verification entity device 14 that the card user is attempting to perform a transaction with the merchant using the payment card.

In order to protect against fraud, the verification entity (such as a credit card company or a clearinghouse that communicates with a credit card company) may desire to verify that the person attempting to perform the transaction with the payment card is the card user that is authorized to use the payment card. For example, the credit card company may desire to verify that a card issued to John Doe is being used by John Doe, as opposed to someone that may have fraudulently obtained the card issued to John Doe. To verify the identity of the person using the payment card, verification entity device 14 may communicate a challenge code 38 to a merchant verification device 62 (via initial challenge message 158) that is associated with the merchant. Merchant verification device 62 may receive the challenge code 38 and re-communicate the challenge code 38 (via subsequent challenge message 162) to a card user device 86 carried by the card user (such as a wireless identification tag attached to the keys of John Doe). The challenge code 38 may interrogate the card user device 86, causing the card user device 86 to select a verification code 106 (via a predefined manner of verification management application 46b) and communicate (via initial verification response message 166) the verification code 106 back to merchant verification device 62. Merchant verification device 62 may then re-communicate the verification code 106 to verification entity device 14 (via subsequent verification response message 170).

Following receipt of verification code 106, verification entity device 14 may select a comparison code 42 (via the predefined manner of verification application 46a) to compare to the verification code 106 received from the card user device 86. If the verification code 106 does not match the comparison code 42 (or a verification code 106 is never received in response to a challenge code 38), verification entity device 14 may deny the processing of the transaction by transaction device 58. On the other hand, if the verification code 106 does match the comparison code 42, verification entity device 14 may verify the transaction (or otherwise approve the processing of the transaction) via verification signal 174 communicated to transaction device 58, and the transaction may be allowed to occur. In particular embodiments, this method of verifying a transaction may provide additional protection against fraud. For example, even if a person (or a device) is able to steal or copy a card user's payment card, the person may be unable to conduct one or more transactions using the payment card because the person may not also have the card user device 86. As another example, even if a person (or a device) is also able to attempt to respond to a challenge code 38 using a fraudulent device, the code provided by the fraudulent device may not match the comparison code 42 utilized by the verification entity device 14 because the fraudulent device may not have access to verification codes 106 or the verification management application 46b that results in a verification code 106 being selected in a predefined manner. Further details regarding particular examples of these sequences illustrated in FIG. 1 are discussed below.

As is stated above, a card user may begin a transaction with a merchant by providing a payment card to the merchant via payment 150. Payment 150 may be performed in any suitable manner. As an example, the card user may hand the payment card to the merchant to process the payment card. As another example, the card user (or the merchant) may swipe the payment card through a card reader. As a further example, the card user (or the merchant) may enter information from the payment card (via, for example, typing) in order to process the payment card. Payment 150 may be processed using transaction device 58.

As a result of transaction device 58 processing payment 150, transaction device 58 may communicate indication 154 to verification entity device 14, indicating that that the card user is attempting to perform a transaction with the merchant using the payment card. Indication 154 may include any information about the attempted transaction. For example, indication 154 may include information associated with the payment card (such as the card number, expiration date, and verification number), information associated with the merchant (such as information that identifies the merchant), information associated with the transaction (such as the purchase amount for the transaction and details about what is being purchased), any other information desired by a verification entity for approving a payment card transaction, or any combination of the preceding.

Although indication 154 has been illustrated as being communicated by transaction device 58, in particular embodiments, indication 154 may be communicated by merchant verification device 62. For example, the payment card may first be processed for verification by the merchant verification device 62 (such as by the merchant swiping the payment card through a card reader of the merchant verification device 62). In such an example, the merchant verification device 62 may provide the indication 154 to verification entity device 14, which will verify the transaction (as is discussed herein). Once the transaction is verified, the merchant verification device 62 may signal to the merchant that the payment card may be processed for payment. The merchant may then process the payment card for payment using, for example, the transaction device 58.

Furthermore, although indication 154 has been illustrated as being communicated directly from transaction device 58 to verification entity device 14, in particular embodiments, indication 154 may be communicated to one or more additional devices (not shown) before indication 154 is received by verification entity device 14. For example, indication 154 may first be communicated to a payment processor (such as a payment processing system run by, for example, First Data Merchant Services Corporation), and then the payment processor may re-communicate the indication 154 to verification entity device 14. The payment processor may re-communicate all or a portion of indication 154. Additionally, the payment processor may perform one or more payment processing actions (using the information in indication 154) prior to re-communicating indication 154. In such an example, the payment processor may add information associated with these additional payment processing actions to indication 154 prior to re-communicating indication 154 to verification entity device 14.

Following receipt of indication 154, verification entity device 14 may communicate a challenge code 38 (via initial challenge message 158) for receipt by the card user device 86. As is discussed above, a challenge code 38 represents any code that may be used to interrogate card user device 86 for a verification code 106. For example, a challenge code 38 may be a computer-readable code that forces, requests, or causes a response from card user device 86. In such an example, the challenge code 38 may force, request, or cause the card user device 86 to select a verification code 106 stored at the card user device 86 and communicate the verification code 106 for receipt by the verification entity device 14.

A challenge code 38 may be the same code for all card user devices 86, or may be unique for each card user device 86 (or for one or more card user devices 86). For example, a challenge code 38 for a card user device 86 carried by John Doe may be different than a challenge code 38 for a card user device 86 carried by Jane Doe. Challenge code 38 may be the same challenge code every time it is sent for receipt by a particular card user device 86, or it may be different every time it is sent for receipt by a particular card user device 86. For example, challenge code 38 may include one or more details associated with the transaction (such as the purchase amount, the merchant identification, the time and/or date associated with the transaction or the challenge code 38, etc.), thereby causing it to be different every time it is sent for receipt by the card user device 86 carried by John Doe. As another example, challenge code 38 may include a particular verification management application 46b for use by the card user device 86 for that transaction. As a further example, challenge code 38 may include particular instructions for responding to the challenge code 38 (such as a particular question that is to be answered using the verification code 106).

Following communication of challenge code 38 for receipt by a card user device 86, the challenge code 38 may be received by merchant verification device 62. As is discussed above, merchant verification device 62 may act as an intermediary between verification entity device 14 and card user device 86. By doing so, merchant verification device 62 may receive the challenge code 38 from verification entity device 14 (via initial challenge message 158) and re-communicate the challenge code 38 to card user device 86 (via subsequent challenge message 162). Merchant verification device 62 may re-communicate challenge code 38 in the same form (and/or in the same manner) in which merchant verification device 62 received the challenge code 38. For example, merchant verification device 62 may act as an amplifier (or an access point) that provides a network connection between verification entity device 14 and card user device 86. Additionally (or alternatively), merchant verification device 62 may re-communicate challenge code 38 in a different form (and/or in a different manner) than what merchant verification device 62 received the challenge code 38 as. For example, merchant verification device 62 may receive the challenge code 38 in digital form over a wired connection and re-communicate the challenge code 38 in analog form over a wireless connection. As another example, merchant verification device 62 may receive the challenge code 38 in digital form over a wireless connection and re-communicate the challenge code 38 in a radio frequency (or as a particular audio tone or as an infrared signal) over a different wireless connection. As a further example, merchant verification device 62 may receive the challenge code 38 in a digital form over a wired connection and re-communicate the challenge code 38 as a graphical image (such as a barcode, a QR code, a universal product code (UPC), a matrix bar code, a MaxiCode, or a ShotCode) that may be scanned or copied by the card user device 62. In such examples, merchant verification device 62 may act as a converter to convert challenge code 38 from a form (and/or a communication manner) that cannot be received by the card user device 86 to a form (and/or a communication manner) that can be received by the card user device 86.

Although challenge code 38 has been illustrated as being communicated from verification entity device 14 to merchant verification device 62 and then re-communicated from the merchant verification device 62 to the card user device 86, in particular embodiments, the challenge code 38 may be communicated directly from verification entity device 14 to the card user device 86. For example, the card user device 86 may be a mobile phone that receives the challenge code 38 directly. In such an example, the mobile phone may be running a mobile phone application associated with the verification entity device 14, and the verification entity device 14 may push the challenge code 38 directly to the mobile phone. In response to the challenge code 38, the mobile phone may communicate a verification code 106 to the merchant verification device 62, which may then re-communicate the verification code 106 to the verification entity device 14.

Furthermore, although challenge code 38 has been illustrated as being automatically re-communicated from the merchant verification device 62 to the card user device 86, in particular embodiments, the re-communication (and/or even the original communication) of the challenge code 38 to the card user device 86 may only occur after a signal is first received from the card user device 86. For example, before the challenge code 38 may be received by the card user device 86 (and/or even communicated to the card user device 86), the card user may activate the card user device 86 (such as by pushing a button on the card user device 86 or performing any other user action with the card user device 86). This activation by the card user may cause the card user device 86 to send a signal to the merchant verification device 62 (and/or the verification entity device 14) indicating that the card user device 86 is ready to receive the challenge code 38. Following receipt of this signal from the card user device 86, the challenge code 38 may be communicated to (and received by) the card user device 86.

Following receipt of the challenge code 38 by the card user device 86, the card user device 86 may (in response to the interrogation provided by the challenge code 38) select one of the verification codes 106 stored at the card user device 86. Furthermore, the card user device 86 may communicate the verification code 106 for receipt by the verification entity device 14. As is discussed above, a verification code 106 represents any code that may be used to identify the card user as the approved user of the payment card (as opposed to another person who may have fraudulently obtained the payment card). For example, a verification code 106 may be a predefined code stored at the card user device 86, and may be configured to match a comparison code 42 stored at the verification entity device 14. The verification code 106 may be a password, a set of numbers, a set of alphanumeric characters, a set of symbols, one or more audible tones, one or more radio frequencies, one or more graphical images, any other type of code or representation, or any combination of the preceding. The verification code 106 may have any length, size, or dimension. For example, the verification code 106 may be a 35 character password.

The verification code 106 may match a comparison code 42 when all or a portion of the verification code 106 is identical to all or a portion of the comparison code 42. For example, the verification code 106 may match the comparison code 42 when the last 30 digits of the verification code 106 are identical to the last 30 digits of the comparison code 42. Additionally (or alternatively), the verification code 106 may match a comparison code 42 when the verification code 106 is an answer to the comparison code 42 (such as an answer to a question), when the verification code 106 completes the comparison code 42 (such as a final piece of a puzzle), when the verification code 106 is the opposite of the comparison code 42 (such as the term “up” is the opposite of “down”), any other manner of matching, or any combination of the preceding.

Card user device 86 may store any suitable number of different verification codes 106. For example, card user device 86 may store 2 different verification codes 106, 5 different verification codes 106, 10 different verification codes 106, 15 different verification codes 106, 25 different verification codes 106, 50 different verification codes 106, 100 different verification codes 106, 1,000 different verification codes 106, 10,000 different verification codes 106, 1 million different verification codes 106, or any other number of different verification codes 106. Furthermore, following receipt of the challenge code 38 by the card user device 86, the card user device 86 may select one of the verification codes 106 stored at the card user device 86. The card user device 86 may select one of the verification codes 106 according to a predefined manner based on verification management application 46b. For example, card user device 86 may select one of the verification codes 106 by sequentially rotating through each of the verification codes 106 (e.g., rotating from a first code to a second code), by skipping over a predefined number of the verification codes 106 (e.g., skipping from the first code to the fifth code), by selecting a position of one of the verification codes 106 (e.g., selecting the code positioned in column five, row ten), any other manner of selecting one of the verification codes 106 according to a predefined manner based on verification management application 46b, or any combination of the preceding. Furthermore, selection of the verification code 106 may further include modifying the verification code 106. For example, the verification code 106 may be modified to include information from the challenge code 38, such as all or a portion of the challenge code 38, or details associated with the transaction (e.g., the purchase amount, the merchant identification, the date and/or time associated with the transaction or the challenge code 38, etc.). As another example, the verification code 106 may be modified to include information regarding the date and/or time associated with the selection of the verification code 106. Further details regarding examples of the selection of a verification code 106 are discussed below with regard to FIG. 2.

Following the selection of the verification code 106, the card user device 86 may communicate the verification code 106 to the merchant verification device 62 via initial verification response message 166. The card user device 86 may communicate the verification code 106 to the merchant verification device 62 in any suitable manner (and/or any suitable form). As an example, the card user device 86 may communicate the verification code 106 to the merchant verification device 62 in the same manner of communication (and/or form) by which the card user device 86 received the challenge code 38. In such an example, if the card user device 86 received the challenge code 38 in a particular radio frequency, the card user device 86 may communicate the verification code 106 to the merchant verification device 62 in the same radio frequency. As another example, the card user device 86 may communicate the verification code 106 to the merchant verification device 62 in a different manner of communication (and/or form) than that by which the card user device 86 received the challenge code 38. In such an example, if the card user device 86 received the challenge code 38 as a particular audio tone, the card user device 86 may communicate the verification code 106 to the merchant verification device 62 in a different audio tone, a radio frequency, an infrared signal, a graphical image displayed or sent to the merchant verification device 62, any other manner (and/or form) different from that by which the card user device 86 received the challenge code 38, or any combination of the preceding.

Furthermore, the selection and communication processes of the verification code 106 by the card user device 86 may occur without user intervention. For example, following the reception of the challenge code 38 by the card user device 86, the card user device 86 may both automatically select and communicate the verification code 106 without any intervention by the card user (e.g., without the card user pressing a button, confirming a selection, pointing the card user device 86 in a particular direction, scanning the card user device 86, etc.). As such, verifying the transaction using the card user device 86 may occur without any action by the user, other than the card user actually carrying the card user device 86 with them when performing the transaction (such as carrying the card user device 86 in the card user's purse or attached to the card user's keys). Alternatively, one or more (or both) of the selection and communication processes of the verification code 106 by the card user device 86 may occur with user intervention. For example, selection of the verification code 106 may occur when the card user presses a button on the card user device 86 to select the verification code 106, when the card user points the card user device 86 at the merchant verification device 62 (or hovers the card user device 86 over a scanner at the merchant verification device 62), when the card user performs any other manner of user intervention, or any combination of the preceding. As another example, communication of the verification code 106 may occur when the card user points the card user device 86 at the merchant verification device 62 (or hovers the card user device 86 over a scanner at the merchant verification device 62), when the card user swipes the card user device 86 (such as a smart card) through a card reader on the merchant verification device 62, when the card user presses a button to communicate the verification code 106, any other manner of user intervention, or any combination of the preceding.

Following receipt of the verification code 106 by merchant verification device 62, the merchant verification device 62 may re-communicate the verification code 106 to verification entity device 14 via subsequent verification response message 170. Merchant verification device 62 may re-communicate the verification code 106 in the same form (and/or communication manner) in which merchant verification device 62 received the verification code 106. Furthermore (or alternatively), merchant verification device 62 may re-communicate the verification code 106 in a different form (and/or manner) than by which the merchant verification device 62 received the verification code 106. For example, if the merchant verification device 62 received the verification code 106 via a wireless radio frequency, the merchant verification device 62 may re-communicate the verification code 106 to the verification entity device 14 via a wired internet connection. In such an example, merchant verification device 62 may act as a converter to convert verification code 106 from a form (and/or communication manner) that cannot be received by the verification entity device 14 to a form (or communication manner) that can be received by the verification entity device 14.

Following receipt of the verification code 106 by the verification entity device 14, the verification entity device 14 may select one of the comparison codes 42 stored at the verification entity device 14 for comparison with the verification code 106. As is discussed above, a comparison code 42 represents any code that may be compared to a verification code 106 in order to verify a transaction. For example, a comparison code 42 may be predefined code stored at the verification entity device 14 and that is configured to match a verification code 106 stored at the card user device 86. Similar to the verification code 106, the comparison code 42 may be a password, a set of numbers, a set of alphanumeric characters, a set of symbols, one or more audible tones, one or more radio frequencies, one or more graphical images, any other type of code or representation, or any combination of the preceding. The comparison code 42 may have any length, size, or dimension. For example, the comparison code 42 may be a 35 character password. The comparison code 42 may match a verification code 106 when all or a portion of the comparison code 42 is identical to all or a portion of the verification code 106. Additionally, the comparison code 42 may match a verification code 106 in any of the manners of matching discussed above with regard to verification codes 106.

Verification entity device 14 may store (for each account 34) any suitable number of different comparison codes 42. For example, verification entity device 14 may store (for each account 34) 2 different comparison codes 42, 5 different comparison codes 42, 10 different comparison codes 42, 15 different comparison codes 42, 25 different comparison codes 42, 50 different comparison codes 42, 100 different comparison codes 42, 1,000 different comparison codes 42, 10,000 different comparison codes 42, 1 million different comparison codes 42, or any other number of different comparison codes 42. As another example, verification entity device 14 may store (for each account 34) a matching comparison code 42 for each verification code 106 stored by the card user device 86 (and associated with an account 34). In such an example, if the card user device 86 stores 10 different verification codes 106, the verification entity device 14 may store 10 matching comparison codes 42.

The verification entity device 14 may select one of the comparison codes 42 according to the same predefined manner utilized by the card user device 86. For example, if the card user device 86 selects one of the verification codes 106 by sequentially rotating through each of the verification codes 106 (e.g., rotating from a first code to a second code), the verification entity device 14 may select one of the comparison codes 42 by sequentially rotating through each of the comparison codes 42 (e.g., rotating from a first code to a second code). As such, both the card user device 86 and the verification entity device 14 may utilize the same predefined manner (based on verification management applications 46b and 46a, respectively) to select a matching verification code 106 and comparison code 42. Furthermore, selection of the comparison code 42 may further include modifying comparison code 42. For example, the comparison code 42 may be modified to include information from the challenge code 38, such as all or a portion of the challenge code 38, or details associated with the transaction (e.g., the purchase amount, the merchant identification, the time and/or date associated with the transaction or the challenge code 38, etc.). As another example, the comparison code 42 may be modified to include information regarding the date and/or time associated with the reception of the verification code 106. Further details regarding examples of the selection of a comparison code 42 are discussed below with regard to FIG. 2.

Although the verification entity device 14 has been discussed above as selecting one of the comparison codes 42 according to the same predefined manner utilized by the card user device 86, in particular embodiments, the verification entity device 14 may select one of the comparison codes 42 in a different predefined manner than the card user device 86 (but in a manner that still causes the selected comparison code 42 to match the selected verification code 106). For example, the verification entity device 14 may store the comparison codes 42 in a different order than the card user device 86 stores the matching verification codes 106. In such an example, the verification entity device 14 may select the comparison code 42 using a first predefined manner (such as by sequentially rotating through each of the comparison codes 42, for example) while the card user device 86 may select the matching verification code 106 using a second predefined manner (such as by skipping over a predefined number of the verification codes 106, for example). Furthermore, although selection of the comparison code 42 has been discussed above as occurring after reception of the verification code 106, the comparison code 42 may be selected any time after indication 154 is received by the verification entity device 14. For example, the comparison code 42 may be selected before the challenge code 38 is communicated for receipt by the card user device 86. As another example, the comparison code 42 may be selected after the challenge code 38 is communicated for receipt by the card user device 86, but before the verification entity device 14 receives the verification code 106.

Following receipt of the verification code 106 by the verification entity device 14 and further following selection of the comparison code 42 by the verification entity device 14, the verification entity device 14 may compare the verification code 106 to the comparison code 42 in order to determine whether the verification code 106 matches the comparison code 42. If the verification code 106 does not match the comparison code 42 (or a verification code 106 is never received in response to a challenge code 38), verification entity device 14 may deny the transaction. This denial may result in a denial message (not shown) being sent to transaction device 58, merchant verification device 62, and/or card user device 86. As a result, the transaction will not be allowed to occur. On the other hand, if the verification code 106 does match the comparison code 42, verification entity device 14 may verify the transaction (or otherwise approve the processing of the transaction) by communicating a verification signal 174 to transaction device 58 (and/or one or more of merchant verification device 62 and card user device 86). As such, the transaction may be allowed to occur. The verification signal 174 may allow the transaction to occur in any suitable manner. For example, the verification signal 174 may provide a signal to the merchant (such as a flashing green light on the merchant verification device 62) that indicates that the merchant may now process the payment card using the payment device (such as a cash register). In such an example, the merchant may now run the payment card through the payment device (or any other card reader that may cause the transaction to be processed). As another example, the payment card may already be in the middle of being processed (as a result of the payment card having been run through transaction device 58), and the verification signal 174 may cause (automatically or by signaling the merchant to finalize the transaction by, for example, pushing a button) the processing of the payment card to be completed. In such an example, the merchant may not need to run the payment card through the payment device (or any other card reader) again.

Although verification entity device 14 has been illustrated as comparing a single verification code 106 to a single comparison code 42 in order to verify a particular transaction, in particular embodiments, verification entity device 14 may compare more than one verification code 106 to more than one comparison code 42 in order to verify the particular transaction. For example, for each transaction, two or more verification codes 106 and two or more comparison codes 42 may be selected for the verification process. In such an example, verification entity device 14 may only verify (or otherwise allow) the transaction if each of the selected verification codes 106 match each of the selected comparison codes 42.

Furthermore, although verification entity device 14 has been illustrated as verifying (or otherwise approving) the transaction if the verification code 106 matches the comparison code 42, in particular embodiments, verification (or approval) of the transaction may include various additional steps. For example, verification entity device 14 may determine whether the payment card has been reported lost or stolen, whether the transaction appears suspicious based on the card user's typical purchases, whether there is a sufficient balance associated with the payment card to approve the transaction, whether the transaction will cause a credit limit associated with the payment card (or account 34) to be overdrawn, any other suitable method for determining whether to verify (or approve) the transaction, or any combination of the preceding.

Additionally, although verification entity device 14 has been illustrated as storing and communicating challenge codes 38, storing and selecting comparison codes 42, and verifying the transactions by comparing comparison codes 42 to verification codes 106, in particular embodiments, one or more (or all) of these actions may be performed by other devices or components of system 10, such as transaction device 58, merchant verification device 62, and/or one or more third party devices or components. For example, merchant verification device 62 may store and communicate challenge codes 38, store and select comparison codes 42, and verify the transactions by comparing comparison codes 42 to verification codes 106. In such an example, verification entity device 14 may approve the transaction (or otherwise allow the transaction to occur) if the merchant verification device 62 verifies the transaction and communicates a verification signal (such as verification signal 194) to the verification entity device 14.

In particular embodiments, the above-described method of verifying a transaction may provide additional protection against fraud. For example, even if a person (or a device) is able to steal or copy a card user's payment card, the person may be unable to conduct one or more transactions using the payment card because the person may not also have the card user device 86. As another example, even if a person (or a device) is also able to attempt to respond to a challenge code 38 using a fraudulent device, the code provided by the fraudulent device may not match the comparison code 42 utilized by the verification entity device 14 because the fraudulent device may not have access to verification codes 106 or the verification management application 46b that results in a verification code 106 being selected in a predefined manner.

Modifications, additions, or omissions may be made to system 10 without departing from the scope of the invention. For example, verification entity device 14 may verify any number of transactions that are performed using any number of transaction environments 54, transaction devices 58, merchant verification devices 62, card user devices 86, card users, and/or merchants. Additionally, system 10 may include any number of verification entity devices 14, networks 50, transaction environments 54, transaction devices 58, merchant verification devices 62, networks 82, and/or card user devices 86 (and/or any number of components, such as processors or memory units illustrated in the above described devices). Also, any suitable logic may perform the functions of system 10 and the components and/or devices within system 10.

Furthermore, one or more components of system 10 may be combined. For example, although verification entity device 14 and merchant verification device 62 (and/or transaction device 58) are illustrated as being separate devices, verification entity device 14 and merchant verification device 62 (and/or transaction device 58) may be the same device. In such an example, the single device may be associated with the merchant (e.g., located at the merchant's store) and may verify the transaction. Additionally, system 10 may include additional components. For example, as is discussed above, a payment processor (such as a payment processing system run by, for example, First Data Merchant Services Corporation) may be communicatively located in-between the transaction device 58 and the verification entity device 14. In such an example, all or a portion of one or more communications between transaction device 58 and verification entity device 14 may be communicated through (and/or modified by) the payment processor.

Furthermore, one or more of the communications (such as all of the communications) between verification entity device 14, network 50, transaction environment 54, transaction device 58, merchant verification device 62, network 82, and/or card user device 86 may be encrypted (or otherwise secured in any suitable manner), providing protection against fraudulent attempts to access the information included in the communications. Additionally, one or more of the communications (such as all of the communications) between one or more components of system 10 (such as verification entity devices 14, networks 50, transaction environments 54, transaction devices 58, merchant verification devices 62, networks 82, and/or card user devices 86) may further include one or more codes that may assist in identifying the communication as being sent by one of the devices or components of system 10. For example, the merchant verification device 62 may generate a random code, and insert the code into any communication with the card user device 86. Based on this random code, card user device 86 may be able to identify the communication as having been sent by the merchant verification device 62, and thus the card user device 86 may respond to the communication. In such an example, the card user device 86 may also generate a random code, and insert the code into any communication with the merchant verification device 62. Based on this random code, merchant verification device 62 may be able to identify the communication as having been sent by the card user device 86, and thus the merchant verification device 62 may re-communicate the communication for receipt by the verification entity device 14.

FIG. 2 illustrates an example selection 200 of verification codes 106 and comparison codes 42. Verification codes 106 are selected by the card user device 86 of FIG. 1, and comparison codes 42 are selected by the verification entity device 14 of FIG. 1, for example. Furthermore, following selection (and communication) of verification codes 106 and comparison codes 42, verification entity device 14 may compare verification codes 106 to comparison codes 42 in order to determine whether to allow a transaction to occur, as is discussed above.

Verification codes 106 and comparison codes 42 may each be selected according to a predefined manner based on verification management applications 46. For example, verification codes 106 and comparison codes 42 may be selected by sequentially rotating through each of the verification codes 106 and comparison codes 42 (e.g., rotating from a first code to a second code), by skipping over a predefined number of the verification codes 106 and comparison codes 42 (e.g., skipping from the first code to the fifth code), by selecting a position of one of the verification codes 106 and comparison codes 42 (e.g., selecting the code positioned in column five, row ten), any other manner of selecting one of the verification codes 106 and one of the comparison codes 42 according to a predefined manner based on verification management applications 46, or any combination of the preceding.

As illustrated, verification codes 106 and comparison codes 42 may each be selected by sequentially rotating through each of the verification codes 106 and comparison codes 42. For example, the card user device 86 may store the following verification codes 106: Code A, Code B, Code C, Code D, . . . Code n. Furthermore, the verification entity device 14 may store the following comparison codes 42, each of which match a respective verification code 106: Code A, Code B, Code C, Code D, . . . Code n.

In one example of the operation of selection 200, when a card user attempts to perform a first potential transaction using a payment card (such as when a card user attempts to purchase a shirt from merchant A), the predefined manner (based on verification management application 46b) may cause the card user device 86 to select Code A as the verification code 106 for communication to the verification entity device 14. Furthermore, the same predefined manner (based on verification management application 46a) may cause the verification entity device 14 to select the matching Code A as the comparison code 42. As such, the verification code 106 (i.e., Code A) will match comparison code 42 (i.e., Code A), and the first transaction will be allowed to proceed.

For the second potential transaction of the card user (such as when the card user attempts to purchase shoes from merchant B), the predefined manner (based on verification management application 46b) may cause the card user device 86 to sequentially rotate to and select Code B as the verification code 106 for communication to the verification entity device 14. That is, the sequential rotation may cause the card user device 86 to rotate to and select the next verification code 106 (i.e., Code B) in the sequence of verification codes 106. Furthermore, the same predefined manner (based on verification management application 46a) may cause the verification entity device 14 to sequentially rotate to and select the matching Code B as the comparison code 42. As such, the verification code 106 (i.e., Code B) will match the comparison code 42 (i.e., Code B), and the second transaction will be allowed to proceed.

This sequential rotation through (and selection of) the verification codes 106 and comparison codes 42 may continue until Code n is selected for both the verification code 106 and the comparison code 42. After Code n is selected, the process of selecting verification codes 106 and comparison codes 42 may be reset (as is seen by resets 204a and 204b) back to Code A. Therefore, for the next potential transaction of the card user (such as when the card user attempts to pay for a hair cut from merchant O), the predefined manner (based on verification management application 46b) may cause the card user device 86 to sequentially rotate to (via reset 204a) and re-select Code A as the verification code 106 for communication to the verification entity device 14. Furthermore, the same predefined manner (based on verification management application 46a) may cause the verification entity device 14 to sequentially rotate to (via reset 204b) and re-select the matching Code A as the comparison code 42. As such, the verification code 106 (i.e., Code A) will match the comparison code 42 (i.e., Code A), and the next transaction will be allowed to proceed.

Based on the sequential rotation through verification codes 106 and comparison codes 42, the verification codes 106 and comparison codes 42 may be rotated through continuously. This may allow the same code to be re-used as the verification code 106 and comparison code 42 at a later date and/or time from the original use of the code. As such, the card user device 86 may not need to receive new verification codes 106 from verification entity device 14 (or some other device associated with the verification entity) when all of the verification codes 106 have already been used.

Modifications, additions, or omissions may be made to selection 200 without departing from the scope of the invention. For example, although selection 200 illustrates a sequential rotation for selecting verification codes 106 and comparison codes 42, any other manner of selecting one of the verification codes 106 and one of the comparison codes 42 may be utilized (such as a reverse sequential rotation where the rotation process rotates from Code B to Code A; skipping over a predefined number of the verification codes 106 and comparison codes 42; selecting a position of one of the verification codes 106 and comparison codes 42; or any combination of the preceding). Additionally, selection 200 may be performed using any number of verification codes 106 and comparison codes 42.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or reorganizing any of the disclosed steps, components, elements, features, aspects, characteristics, limitations, and the like, of the various non-limiting and non-exhaustive embodiments described in this specification. In this manner, Applicant reserves the right to amend the claims during prosecution to add features as variously described in this specification, and such amendments comply with the requirements of 35 U.S.C. §§112(a) and 132(a).

1. A transaction verification system, comprising:
one or more memory units configured to:
store one or more instructions; and
store a plurality of comparison codes; and
one or more processors coupled to the memory units and configured, upon executing the one or more instructions, to:
receive an indication that a card user is attempting to perform a transaction with a payment card;
following reception of the indication, transmit a challenge code for reception by a card user device, the challenge code configured to interrogate the card user device for a first verification code;
following transmittal of the challenge code, receive the first verification code from the card user device, wherein the first verification code is selected, by the card user device, from a plurality of verification codes stored by the card user device, wherein the first verification code is selected, by the card user device, according to a predefined manner;
select a first comparison code from the plurality of comparison codes according to the predefined manner;
compare the first comparison code to the first verification code received from the card user device; and
following a determination that the first comparison code matches the first verification code, transmit a verification signal configured to indicate that the transaction has been verified.

2. The transaction verification system of claim 1, wherein:
in accordance with the predefined manner, the one or more processors are further configured to sequentially rotate through the plurality of comparison codes in order to select the first comparison code; and
in accordance with the predefined manner, the first verification code is selected, by the card user device, by sequentially rotating through the plurality of verification codes.

3. The transaction verification system of claim 3, wherein:
in accordance with the predefined manner, the one or more processors are further configured to re-select the first comparison code for use in verifying a subsequent transaction after each of the other comparison codes have been sequentially rotated to and selected; and
in accordance with the predefined manner, the first verification code is re-selected, by the card user device, for use in verifying the subsequent transaction after each of the other verification codes have been sequentially rotated to and selected.

4. The transaction verification system of claim 1, wherein the predefined manner comprises a second set of one or more instructions for selecting the first verification code; and wherein:
the second set of instructions are stored, by the card user device, prior to the card user device receiving the challenge code; or
the second set of instructions are received, by the card user device, as a portion of the challenge code; or
the second set of instructions are received, by the card user device, at substantially the same time or after reception of the challenge code.

5. The transaction verification system of claim 1, further comprising a merchant verification device configured to act as an intermediary between the one or more processors and the card user device, the merchant verification device including a second set of one or more processors configured to:
receive the challenge code prior to the challenge code being received by the card user device;
re-transmit the challenge code for reception by the card user device;
receive the first verification code prior to the first verification code being received by the one or more processors; and
re-transmit the first verification code for reception by the one or more processors.

6. The transaction verification system of claim 1, wherein the card user device comprises one of the following:
a wireless identification tag;
a wired identification tag;
a mobile telephone;
a radio-frequency identification device;
an audio-generation device; or
a smart card.

7. The transaction verification system of claim 1, wherein the first verification code is transmitted by the card user device without intervention by the card user.

8. A non-transitory computer readable medium comprising logic configured, when executed by one or more processors, to:
store a plurality of comparison codes in one or more memory units;
receive an indication that a card user is attempting to perform a transaction with a payment card;
following reception of the indication, transmit a challenge code for reception by a card user device, the challenge code configured to interrogate the card user device for a first verification code;
following transmittal of the challenge code, receive the first verification code from the card user device, wherein the first verification code is selected, by the card user device, from a plurality of verification codes stored by the card user device, wherein the first verification code is selected, by the card user device, according to a predefined manner;
select a first comparison code from the plurality of comparison codes according to the predefined manner;
compare the first comparison code to the first verification code received from the card user device; and
following a determination that the first comparison code matches the first verification code, transmit a verification signal configured to indicate that the transaction has been verified.

9. The non-transitory computer readable medium of claim 8, wherein:
in accordance with the predefined manner, the logic is further configured, when executed by the one or more processors, to sequentially rotate through the plurality of comparison codes in order to select the first comparison code; and
in accordance with the predefined manner, the first verification code is selected, by the card user device, by sequentially rotating through the plurality of verification codes.

10. The non-transitory computer readable medium of claim 9, wherein:
in accordance with the predefined manner, the logic is further configured, when executed by the one or more processors, to re-select the first comparison code for use in verifying a subsequent transaction after each of the other comparison codes have been sequentially rotated to and selected; and
in accordance with the predefined manner, the first verification code is re-selected, by the card user device, for use in verifying the subsequent transaction after each of the other verification codes have been sequentially rotated to and selected.

11. The non-transitory computer readable medium of claim 8, wherein the predefined manner comprises additional logic for selecting the first verification code; and wherein:
the additional logic is stored, by the card user device, prior to the card user device receiving the challenge code; or
the additional logic is received, by the card user device, as a portion of the challenge code; or
the additional logic is received, by the card user device, at substantially the same time or after reception of the challenge code.

12. The non-transitory computer readable medium of claim 8, wherein the card user device comprises one of the following:
a wireless identification tag;
a wired identification tag;
a mobile telephone;
a radio-frequency identification device;
an audio-generation device; or
a smart card.

13. The non-transitory computer readable medium of claim 8, wherein the first verification code is transmitted by the card user device without intervention by the card user.

14. A method, comprising:
storing, by one or more processors, a plurality of comparison codes at one or more memory units;
receiving, by the one or more processors, an indication that a card user is attempting to perform a transaction with a payment card;
following reception of the indication, transmitting, by the one or more processors, a challenge code for reception by a card user device, the challenge code configured to interrogate the card user device for a first verification code;
following transmittal of the challenge code, receiving, by the one or more processors, the first verification code from the card user device, wherein the first verification code is selected, by the card user device, from a plurality of verification codes stored by the card user device, wherein the first verification code is selected, by the card user device, according to a predefined manner;
selecting, by the one or more processors, a first comparison code from the plurality of comparison codes according to the predefined manner;
comparing, by the one or more processors, the first comparison code to the first verification code received from the card user device; and
following a determination that the first comparison code matches the first verification code, transmitting, by the one or more processors, a verification signal configured to indicate that the transaction has been verified.

15. The method of claim 14, wherein:
in accordance with the predefined manner, the first comparison code is selected, by the one or more processors, by sequentially rotating through the plurality of comparison codes; and
in accordance with the predefined manner, the first verification code is selected, by the card user device, by sequentially rotating through the plurality of verification codes.

16. The method of claim 15, further comprising, in accordance with the predefined manner, re-selecting, by the one or more processors, the first comparison code for use in verifying a subsequent transaction after each of the other comparison codes have been sequentially rotated to and selected, wherein, in accordance with the predefined manner, the first verification code is re-selected, by the card user device, for use in verifying the subsequent transaction after each of the other verification codes have been sequentially rotated to and selected.

17. The method of claim 14, wherein the predefined manner comprises one or more instructions for selecting the first verification code; and wherein:
the one or more instructions are stored, by the card user device, prior to the card user device receiving the challenge code; or
the one or more instructions are received, by the card user device, as a portion of the challenge code; or
the one or more instructions are received, by the card user device, at substantially the same time or after reception of the challenge code.

18. The method of claim 14, further comprising:
receiving, by a merchant verification device, the challenge code prior to the challenge code being received by the card user device, wherein the merchant verification device is configured to act as an intermediary between the one or more processors and the card user device;
re-transmitting, by the merchant verification device, the challenge code for reception by the card user device;
receiving, by the merchant verification device, the first verification code prior to the first verification code being received by the one or more processors; and
re-transmitting, by the merchant verification device, the first verification code for reception by the one or more processors.

19. The method of claim 14, wherein the card user device comprises one of the following:
a wireless identification tag;
a wired identification tag;
a mobile telephone;
a radio-frequency identification device;
an audio-generation device; or
a smart card.

20. The method of claim 14, wherein the first verification code is transmitted by the card user device without intervention by the card user.
